(19) United States
(12) Patent Application Publication
(10) Pub. No.: US 2021/0134170 A1
(43) Pub. Date: May 6, 2021

(54) SYSTEM AND METHOD FOR IMPLEMENTING AN INDIVIDUALIZED EDUCATION PLAN

(71) Applicant: Objective Ed, Inc., Wellington, FL (US)

(72) Inventors: Martin Schultz, Miami Beach, FL (US); Luke Voelk, Harvard, MA (US)

(21) Appl. No.: 17/085,607

(22) Filed: Oct. 30, 2020

Related U.S. Application Data
(60) Provisional application No. 62/928,067, filed on Oct. 30, 2019.

(51) Int. Cl. G09B 5/12; G09B 5/06; A63F 13/80; A63F 13/67

(52) U.S. Cl. CPC G09B 5/12; A63F 13/67; A63F 13/80; G09B 5/065

(57) ABSTRACT

A system for implementing an individualized education plan (IEP) has a database storing a goal of the IEP, an objective of an IEP, skill sets to learn determined as a function of the IEP, and a list of games, each game requiring a skill set determined as a function of the IEP. A browser communicates with the database. The browser selects an IEP, a specific skill to learn, and a game; selected as a function of the skills to learn. A game controller communicates with the database and receives the skill to learn and the selected game and determines rules of operation of the game as a function of the game and the selected skills to learn. A gaming device, communicates with the game controller, and operating in accordance with the rules of operation produces performance information as a function of gameplay. The game controller determines progress of the skills to be acquired as a function of the performance information.

### CROSS REFERENCE TO RELATED APPLICATIONS

This application claims the benefit of U.S. Provisional Application No. 62/928,067 filed on Oct. 30, 2019. The entire contents of this application is incorporated herein by reference in its entirety.

### FIELD OF INVENTION

The invention disclosed herein relates generally to a system for implementing and monitoring education progress of a student, and more specifically to a system for teaching desired skills, and in an objective manner, determining whether a student has met criteria corresponding to those skills.

### BACKGROUND OF THE INVENTION

Currently, in several areas of education an Individualized Educational Plan (“IEP”) is created for a student, and instruction for that student follows this plan. The IEP consists of major goals, and those goals are segmented into specific objectives. When all the objectives have been met, the goal is considered attained. An IEP also contains a concept of a progress report. The progress made on each objective is tracked, and when the progress reaches 100%, the objective is considered attained. Traditionally, an IEP team at a school creates the IEP: the team includes teachers and assorted specialists and therapists.

At the beginning of each year, an IEP plan is created by the team, outlining accommodations, goals and objectives. Once the team and the parents have approved it, the plan is implemented. Teachers and specialists are assigned to implement the plan, providing services to the child one or more times per week or per month, to achieve those objectives. These services, and the child's progress to achieve the objectives, are updated regularly in the IEP. The teacher or specialist providing the service to the student determines the how much progress was made. In some cases, the child takes a test to determine if the objective was met; more often than not, it's a subjective opinion by the specialist. As a result bias as to goal achievement and inconsistency of standards as applied sneak into the administration of the IEP.

Accordingly a system which overcomes the shortcomings of the prior art by removing accomplishment bias and normalizing teaching of the desired skill sets is desired.

### SUMMARY OF THE INVENTION

A system for implementing an individualized education plan includes a database. The database stores the goals and objectives contained within the IEP for each student, skill sets to learn (determined as a function of the goals and objectives), and a list of games. Each game requires at least one skill set, from the skill sets to learn, to perform. A planner's web browser is in communication with a student management server which communicates with the cloud database. The planner's web browser selects a student, the specific skill set to learn as a function of the selected student's goals and objectives, and one or more games; the game is being selected as a function of the skills to learn. The student management server communicates with the database and the planner's web browser. A game controller receives the skills to learn and the games as selected at the planner's web, and as input, to the student management server and for each game determines rules of operation of the game as a function of the game and the selected skills to learn. A game is made available at the gaming device and operates in accordance with the rules of operation as determined by the gaming controller and produces performance information as a function of gameplay. The game controller, as a function of the performance information, changes the rules of the game and transfers the performance information to the analysis server to determine a student's progress with respect to the desired skill set.

### BRIEF DESCRIPTION OF THE DRAWINGS

The present disclosure is better understood by reading the written description with reference to the accompanying drawings and figures in which like reference numerals denote similar structure and refer to the elements throughout, in which:

FIG. 1 is a schematic diagram of a system constructed and operating in accordance with the invention; and

FIG.2 is a flowchart for operation of the system in accordance with the invention. While various embodiments are amenable to various modifications and alternative forms, specifics thereof have been shown by way of example in the drawings and will be described in detail. It should be understood, however that the intention is not to limit the claimed inventions to the particular embodiments described. On the contrary, the intention is to cover all modifications, equivalents and alternatives falling within the spirit and scope of the subject matter as defined by the claims.

### DETAILED DESCRIPTION OF THE PREFERRED EMBODIMENTS

The subject matter of aspects of embodiments of the present invention is described with specificity herein to meet statutory requirements. However, the description itself is not intended to limit the scope of any patent issuing from this description. Rather, the inventor has contemplated that the claimed subject matter might also be embodied in other ways, to include different elements or combinations of elements similar to the ones described in this document, in conjunction with other present or future technologies.

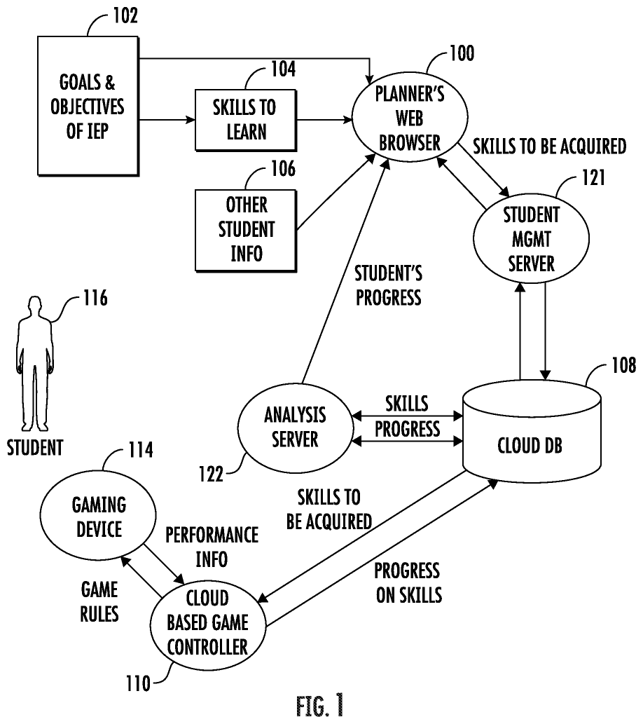

Reference is made to FIG.1 in which a system for applying skills based on an IEP, administering an IEP, and monitoring the extent to which the skills are accomplished is shown. A planner's web browser 100 receives inputs in the form of goals and objectives 102, skills to learn 104, and other student information 106.

The IEP 102, as known in the art, is a document created by a school, and more particularly the IEP team and contains the identification of a child's needs for further development, and the curriculum to address those needs.

Most commonly the need may be a disability to be addressed, but, may merely be a skill set for which improvement is desired. In developing the goals and objectives of any IEP 102, a committee may determine how deficient a child is in an ability and what needs to be addressed; the objectives for addressing the needs. By way of nonlimiting example, the need or disability may be blindness. The student may have no idea how to navigate to an area, determine left from right, or understand compass points relative to a physical position. IEP 102 is the documentation of this information. The objectives would be learning each of the identified deficient skill sets.

From the IEP 102, skills to learn 104 are determined. These are the skills for which a student 116 needs to demonstrate mastery based upon each objective. In a nonlimiting example, utilizing the example of blindness, the needed skills may be the ability to move the gaming device left upon cue, the ability to move the gaming device right upon cue, and the ability for student 116 to recognize when they moved the gaming device and to what extent. Skills to learn 104 is a collection of data or a document, corresponding to the specific embodiments of the goals and objectives of IEP 102, input to planner's web browser 100.

Other student information 106 is by way of nonlimiting example, student demographic information. It may be a child identifying information, such as age, developmental level, or disability. Other student information 106 may also be a collection of data or a document which is input to planner's web browser 100 and stored in the database 108 via a student management server 121 as discussed below.

Planner's web browser 100 is utilized by a teacher in a nonlimiting embodiment to create a plan of action to be performed by a student 116 to learn the identified skills and skills to learn 104 and meet the objectives identified in IEP 102. The planner utilizes the planner's web browser 100 to review the goals and objectives of an IEP 102 and select specific skills currently needed 104 to meet a current objective. The skills may be presented to the curriculum planner at web planner browser 100 by way of a drop-down list.

Web planner's browser 100 also communicates with the student management server 121 that communicates with database 108; preferably located in the cloud. Cloud-based database 108 stores solutions for skill development such as games which can be played to engage a student 116 to learn a skill set to meet the desired objectives. Cloud-based database 108 also stores the child information data including other student information 106 and skills to learn data 104. The solutions are accessible by, and/or input to, planner's web browser 100. As a result, a list of games that can be utilized to develop the skills of interest as a function of a selected specific skill is presented to the teacher at planner's web browser 100.

Cloud based database 108 stores information from students corresponding to a number of different educators. This information as discussed above may be generic, IEP specific, confidential, sensitive, or even governed by rules such as HIPPA. Additionally, cloud based database 108 communicates with a number of planner web browsers 100 (not shown for ease of description). Therefore, to protect the information stored in cloud database 108 and manage the access of planner's web browser 100 to the data stored therein, student management server 121 is functionally and operationally placed between cloud-based database 108 and each of the planner web browsers 100, operatively communicating with each, to control access to the data within cloud-based database 108; to apply rules of engagement.

The planner's web browser 100 determines the skills to be acquired as a function of the goals and objectives of the IEP 102 and more particularly skills to learn 104 and selects at least one game or games to develop the skills and provides the skill and the selected games as an output to the student management server 121 connected to the cloud-based database 108.

Planner's web-based browser 100 may take the form of a PC, a laptop, a tablet, or other portable computing device capable of communicating with cloud-based database 108. Additionally, the solutions may be stored in cloud-based database 108 while the child information data may be stored in a separate accessible local cloud-based database.

A cloud-based game controller 110 operatively communicates with cloud-based database 108 and a student gaming device 114. Cloud-based game controller 110 determines the rules of operation of the games, as identified by student management server 121, to be played on a student's gaming device. Cloud based game controller 110 receives the set of skills to be learned from cloud-based database 108 as well as the games selected by the planner at planner's web browser 100 to determine which games are to be played and how it is to be played as a function of the skills to be taught. Cloud-based game controller 110 then downloads the games with the appropriate rules and controls or enables the games to be played at gaming device 114 in accordance with the determined games rules.

Gaming device 114 may be a PC, handheld device, phone, joystick, gaming piece, or the like. As discussed above, student gaming device 114 may have a game pre-loaded thereon and the type of access provided to student 116 to the game at student's gaming device 114 is in response to the game rules and instructions from the cloud based game controller 110.

By way of nonlimiting example, a very simple game might tell the student to press the screen when a sound is in their left ear. A more complex game would require the student to find a cow on the screen by listening to directions (“the cow is at 2 o'clock from where your finger is”), slide their finger in that direction, and then drag the cow to the north edge (top) of the screen.

Student gaming device 114, as known in the art, determines a score and performs basic analytics. The analytics are based on performance of a specific task. How often was the student response right or wrong?; or even did the student touch the gaming device screen in the correct area? This developed quantitative data is sent as performance information, progress on skills, to cloud-based data 108. It may be sent directly, or to game-based controller 110, and in turn, to cloud-based database 108 where it is mapped to an individual child record utilizing the other student information 106.

An analysis server 122 utilizing the progress on skills data (determined as a function of saved past game scores and a current game score) determines whether, and to what extent, desired skills have been acquired, and generates a skills acquisition progress report, as a function of the determination, the skills acquisition progress report being made available at planner's web browser 100. As a result of a determination of skill acquisition based upon the measurable quantitative information the bias in determining skill set completion is removed. Furthermore, the cloud-based game controller 110 receiving performance information may automatically adjust the game rules to address the areas of need as a function of the determined progress on skills, or to be used as an input for a server such as analysis server 122.

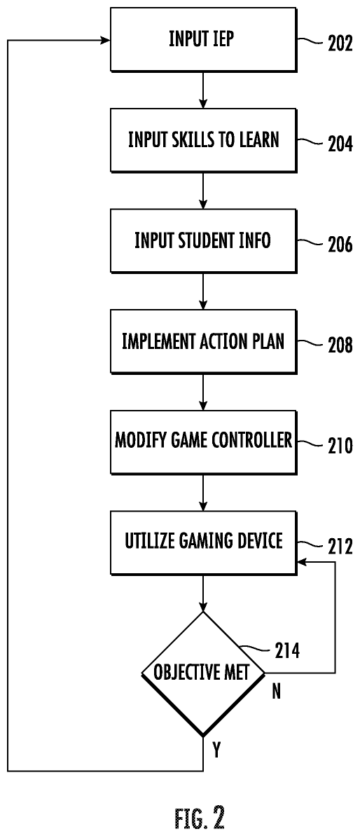

Reference is now made to FIG. 2 where a flowchart describing operation of system 10 is provided. In a step 202 an IEP is developed for a particular student 116 and the corresponding goals and objectives are input to planner's web browser 100, and in turn, student management server 121, and stored at cloud-based database 108, or some other third-party source. In a step 204 skills to learn for an individual student 116 are derived from the goals and the objectives of the IEP 102 and input to system 10. Student information 106 about a student 116 is input to system 10 in a step 206. This is the initialization of the system.

In a step 208 a user utilizing planner's web browser 100 implements an action plan. The user, most often a teacher, reviews the goals and objectives of the IEP 102 at the planner's web browser 100. The skills to learn input 104 is available from a drop down menu or the like presented at planner's web browser 100. The user selects games to develop the selected skills from a drop-down list of available games corresponding to a solution for developing the desired skills and objectives. The selected solution, in the form of games for developing the selected skills, is transmitted from the planner's web browser 100 as an action plan.

In a step 210, the cloud-based game controller 110 receives the identified skills to be acquired as an input and the games associated with those skills. In response to the skills to be acquired, cloud-based game controller 110 modifies the rules and/or modes of operation of student gaming device 114 and transmits the game rules to student gaming device 114 to be used by student 116 to develop the desired skills to obtain the desired objectives. In this way the games played at student gaming device 114 are student specific.

In a step 212 student 116 utilizes student gaming device 114 in accordance with the input game rules to develop the acquired skills by playing the games. Again, as discussed above in a nonlimiting embodiment the game controller 110 has the ability to control the student gaming device 114 to cause the student gaming device 114 to indicate movement right or left in response to cues as in driving a virtual car around the track in response to audio cues by moving the gaming device 114 left or right. Performance information, such as task completion, percentage of correct gameplay versus inability to play the game to completion and other analytic data is output as performance information to cloud-based game controller 110 and in turn to analysis server 122.

At least one of cloud-based game controller 110 or analysis server 122 determines an amount of progress made on developing the identified skill set; the extent to which the objectives were met in a step 214. If the objectives are met, the process returns to step 202 where other goals and objectives are used to practice different skills and games. If the objectives are not met in step 214, the games are again played step 212 until the skill set has been sufficiently mastered to have been considered to meet the objectives as determined in step 208. In an alternative embodiment analysis server 122 may utilize the analytic data to alter the game rules to modify the game to obtain the objective, accomplish the skill set, in a different way. In either event analysis server 122 utilizes the analytic data to revise the game rules to address any determined deficiencies, or to build new skill levels, and reports to planner's web browser 100.

In summary, the IEP teacher sets the objectives for the student 116 utilizing the web based console at planner's web browser 100. That information is stored at cloud database 108; a secure cloud in the preferred nonlimiting embodiment. The game or interactive simulation would use the objectives stored in the cloud to control gameplay behavior. The progress of student 116 would be measured by accomplishing tasks within the game. Accomplishing the specified task, or requiring the skill needed to accomplish the objective, would allow the student to unlock new exciting features of the game or moved from skill level to level as authorized by cloud-based game controller 110. It should be noted, that the game device may also be replaced by a simulator requiring interactive activity.

The progress of student 116 in the game and proof of skill acquisition is stored in the cloud, preferably cloud-based database 108; available for the IEP teacher to review at planner's web browser 100. By way of example, it might show that student 116 executed an action that used the left versus right concept and that the student made the correct choice 80% of the time. This progress information would make a part of the IEP's progress in service delivery section.

As a result of the feedback nature of the implementation of system 10, based on the data analytics from each student's gameplay and progress at acquiring skills, system 10 will dynamically propose new game levels and new games to improve the identified skills. Based on the analytic data from many students, through machine learning, system 10 will propose games and game levels that match the IEP for the student.

Furthermore, as a result of the above described system a game which is appealingly interactive to the student provides interactive simulations to teach and practice the skills related to the objective, store the progress of the skills in a private, secure cloud, and display a student's progress in a web-based dashboard and update the IEP with the progress achieved. As is readily seen, by maintaining the student's progress in the cloud, the system provides a closed loop distributed education system in which a student is taught a skill utilizing a guided interactive simulation/game; the student is tested in a non-guided interactive game; and the student does not perform well, as determined in a nonbiased manner, the system will teach the skill in a different manner.

The above description was made in addressing skill sets required by students with disabilities. However it should be readily apparent that the above system is a personalized learning digital content curriculum. It has applicability to creating any personalized and adaptive content and curricula to meet the needs of any student. It integrates technology skills into the classroom and is mobile as both the planner's web browser and student gaming device may be utilized on mobile handheld devices communicating with the cloud. The result is a digital professional development resource for teachers which utilizes student information to employ a learning management system by enabling and analyzing a curriculum and effectiveness on a student by student basis.

The foregoing description is considered as illustrative only of the principles of the invention. Further, since numerous modifications and changes will be readily apparent to those skilled in the art, it is not desired to limit the invention to the exact construction and process shown as described above. Accordingly, all suitable modifications and equivalents may be resorted to falling within the scope of the invention as defined by the claims that follow.

What is claimed is:

1. A system for implementing an individualized education plan comprising:
a database storing at least one goal of an individualized education plan (IEP), at least one objective of an IEP corresponding to the goal; each goal being formed of one or more objectives, skill sets to learn determined as a function of the at least one objective, and a list of games, each game requiring at least one skill set of the skill sets determined as a function of the objective;
a planner's web browser in communication with the database,
the planner's web browser selecting an IEP, a specific skill to learn as a function of the selected IEP, and at least one game, the at least one game being selected as a function of the skills to learn;
a game controller communicating with the database, the game controller receiving the skill to learn, and the at least one game as selected at the planner's web browser and determining rules of operation of the at least one game as a function of the game and the selected skills to learn; and
a gaming device, communicating with the game controller, and operating in accordance with the rules of operation and producing performance information as a function of a gameplay; the game controller determining a progress of the skills to be acquired as a function of the performance information.

2. The system for implementing an individualized education plan of claim 1, further comprising an analysis server communicating with the the database, receiving the skill sets and the progress of the skills, and determining a level of skill which has been acquired by a student utilizing the gaming device, and which objectives have been achieved, and changing the rules of the game as a function of at least one of the progress of skill acquired and objective achieved.

3. The system for implementing an individualized education plan of claim 1, wherein the game controller changes the rules of the game as a function of the progress of the skills to be acquired.

4. The system for implementing an individualized education plan of claim 1, wherein the analysis server communicates with the web planner's web browser, creates a student progress report as a function of skills and the progress, and transmits the student progress report to the planner's web browser.

5. The system for implementing an individualized education plan of claim 2, wherein the analysis server determines whether a goal has been achieved as a function of the objectives achieved.

6. A method for implementing an individualized education plan (IEP) comprising the steps of:
initializing a system by inputting to a planner's web browser at least one goal and at least one objective corresponding to the at least one goal from an IEP for a student;
and deriving skills to learn for a student as a function of the at least one objective;
at a web browser determining a skill to learn as a function of the at least one objective and selecting a game as a function of the skill to learn;
providing a game controller receiving the skills to learn and the game and modifies a mode of operation of a gaming device as a function thereof.

7. The method for implementing an individualized education plan (IEP) of claim 6, further comprising the steps of the game controller monitoring use of the gaming device and determining an amount of progress in performing the skill set as a function of the objective.

8. The method for implementing an individualized education plan (IEP) of claim 7, further comprising the steps of determining whether the objective has been met, and the game controller modifying rules of the game as a function of the determination.
